(19) United States
(12) Patent Application Publication
(10) Pub. No.: US 2025/0306488 A1
(43) Pub. Date: Oct. 2, 2025

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Narumasa SATO, Kanagawa (JP); Mako TSUCHIYA, Kanagawa (JP); Eiji KAWAKAMI, Kanagawa (JP); Daisuke ISHIZUKA, Kanagawa (JP); Noriyuki MIZUTANI, Kanagawa (JP)

(73) Assignee: FUJIFILM Business Innovation Corp., Tokyo (JP)

(21) Appl. No.: 19/026,550

(22) Filed: Jan. 17, 2025

(30) Foreign Application Priority Data
Mar. 27, 2024 (JP) 2024-052551
Jul. 19, 2024 (JP) 2024-116274

(51) Int. Cl. G03G 9/087

(52) U.S. Cl. CPC G03G 9/08755; G03G 2215/0604; G03G 2215/066; G03G 2221/183

(57) ABSTRACT

An electrostatic charge image developing toner contains toner particles that contain an amorphous polyester resin and a crystalline resin as a binder resin, in which the toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B), a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is 0.5% or more and 10.0% or less in terms of molar ratio, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

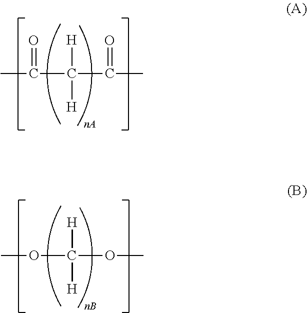

In Structural formulae (A) and (B), nA and nB each independently represent an integer of 2 or more and 12 or less.

### CROSS-REFERENCE TO RELATED APPLICATIONS

This application is based on and claims priority under 35 USC 119 from Japanese Patent Application No. 2024-116274 filed Jul. 19, 2024 and Japanese Patent Application No. 2024-052551 filed Mar. 27, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2023-48127A discloses “electrostatic charge image developing toner containing toner particles that contains a binder resin, in which, in a dynamic viscoelasticity measurement of the electrostatic image developing toner, in a case where a loss tangent tan δ at a temperature of 90° C. and a strain of 1% is defined as D1(90), a loss tangent tan δ at a temperature of 90° C. and a strain of 50% is defined as D50(90), a loss tangent tan δ at a temperature of 150° C. and a strain of 1% is defined as D1(150), and a loss tangent tan δ at a temperature of 150° C. and a strain of 50% is defined as D50(150), D1(90), D50(90), D1(150), and D50(150) are each 0.5 or more and 2.5 or less, a value of D50(150)-D1(150) is less than 1.5, a value of D50(90)-D1(90) is less than 1.0, the toner particles further contain resin particles, and a number-average molecular weight of tetrahydrofuran-soluble components in the toner particles is 5,000 or more and 15,000 or less”.

JP2012-93704A discloses “electrostatic charge image developing toner containing at least a binder resin, a colorant, and a wax, in which the binder resin component includes a non-crystalline polyester resin and a crystalline polyester resin as a principle component, the crystalline polyester resin is contained in an amount of 1 part by mass or more and 15 parts by mass or less with respect to 100 parts by mass of the binder resin, a melting point A of the crystalline polyester resin and a temperature B at which a storage elastic modulus G′ is 20,000 Pa satisfy an expression (1): B−A<20, and a loss tangent at 80° C. or higher is 1 or less”.

### SUMMARY

Aspects of non-limiting embodiments of the present disclosure relate to an electrostatic charge image developing toner that contains toner particles that contain an amorphous polyester resin and a crystalline resin as a binder resin, in which the toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B), where the electrostatic charge image developing toner can suppress end part stains of a recording medium while having low-temperature fixability, as compared with a case where a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is less than 0.5% or more than 10.0% in terms of molar ratio, or a case where, in a dynamic viscoelasticity measurement of the toner particles in a case where a temperature is raised from 30° C. to 120° C., a minimal value tan δ(min) of a loss tangent, present at 50° C. or higher and 80° C. or lower, is less than 0.5 or more than 1.0.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above object include the following.

According to an aspect of the present disclosure, there is provided an electrostatic charge image developing toner containing toner particles that contain an amorphous polyester resin and a crystalline resin as a binder resin, in which the toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B), a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is 0.5% or more and 10.0% or less in terms of molar ratio, and in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less,

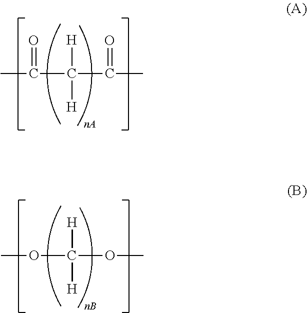

in Structural formulae (A) and (B), nA and nB each independently represent an integer of 2 or more and 12 or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

Hereinafter, exemplary embodiments of the present invention will be described. The following descriptions and examples merely illustrate the exemplary embodiments, and do not limit the scope of the invention.

Regarding the numerical ranges described in stages in the present specification, the upper limit value or lower limit value of a numerical range may be replaced with the upper limit value or lower limit value of another numerical range described in stages. In addition, in the present specification, the upper limit value or lower limit value of a numerical range may be replaced with values described in examples.

In the present specification, (meth)acrylic means both acrylic and methacrylic.

In the present specification, the term “step” includes not only an independent step but a step that is not clearly distinguished from other steps as long as the intended purpose of the step is achieved.

Each component may include a plurality of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

### Electrostatic Charge Image Developing Toner

The electrostatic charge image developing toner (hereinafter, also referred to as “toner”) according to the present exemplary embodiment has toner particles containing an amorphous polyester resin and a crystalline resin as a binder resin.

The toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B), land a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is 0.5% or more and 10.0% or less in terms of molar ratio.

In a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less.

With the above-described configuration, the toner according to the present exemplary embodiment can suppress end part stains of a recording medium while having low-temperature fixability. The reason is presumed as follows.

From the viewpoint of energy saving, high-speed image formation, and the like, a toner having low-temperature fixability is required. By applying a crystalline resin, sharp meltability can be imparted to the toner particles, and the low-temperature fixability can be ensured.

On the other hand, viscoelasticity of the toner during melting is usually a high loss tangent tan δ, and thus an adhesion force between the toner and a fixing member is increased more than an adhesion force between the toner and a recording medium, and a phenomenon in which a part of the melted toner adheres to the fixing member occurs. In particular, the present phenomenon is likely to occur in isolated toner in which cohesive force between the toners does not work, and although defects are not observed on the image, a phenomenon (so-called non-visual offset: NVO) in which the isolated toner adheres to the fixing member occurs.

In a case where the non-visual offset is repeated, the adhering toner is accumulated, and the recording medium transport roll is contaminated, stains are generated on the end part of the recording medium.

Therefore, in the toner according to the present exemplary embodiment, the amorphous polyester resin (S) in which at least one of the constitutional unit derived from the aliphatic dicarboxylic acid represented by Structural Formula (A) or the constitutional unit derived from the aliphatic diol represented by Structural Formula (B) is contained at a specific molar ratio with respect to all constitutional units of the entire amorphous polyester resin of the toner particles is employed.

The constitutional unit derived from the aliphatic dicarboxylic acid represented by Structural Formula (A) and the constitutional unit derived from the aliphatic diol represented by Structural Formula (B) are relatively flexible portions, and thus relatively flexible portions can be imparted to the inside of the toner particles.

Therefore, due to the relatively flexible portion, even in a case where a surface of the recording medium has unevenness, the toner particles are likely to be deformed in response to pressure applied during fixing. As a result, the non-visual offset is suppressed.

Here, in a case where the amounts of the constitutional unit derived from the aliphatic dicarboxylic acid represented by Structural formula (A) and the constitutional unit derived from the aliphatic diol represented by Structural formula (B) are increased, a large number of the flexible portions can be imparted to the toner particles, but in a case where the amounts are excessively increased, the flexible portions are excessive, and thus the adhesiveness to the fixing member is increased and causes the non-visual offset. In addition, a glass transition temperature Tg of the toner particles is excessively decreased, and other characteristics such as thermal storage properties are decreased. Therefore, the proportion of the total of the constitutional units with respect to all the constitutional units is set to 10% or less in terms of molar ratio.

In addition, in the constitutional unit derived from the aliphatic dicarboxylic acid represented by Structural formula (A) and the constitutional unit derived from the aliphatic diol represented by Structural Formula (B), the “number of n” in “(—CH₂—)ₙ” in the structural unit is 2 to 12 and the length of the carbon chain is an appropriate length, and thus it is possible to enhance affinity with the crystalline resin while providing the flexible portion in the toner particles. Therefore, both low-temperature fixability and non-visual offset suppression are improved.

In addition, in the dynamic viscoelasticity measurement of the toner particles in a case where the temperature is raised from 30° C. to 120° C., the minimal value tan δ(min) of the loss tangent at 50° C. or higher and 80° C. lower is 0.5 or more and 1.0 or less, and thus the properties of the toner in a temperature range of 50° C. to 80° C., in which the toner begins to melt, are elastically controlled. That is, by elastically controlling the viscoelasticity of the toner during melting to a low loss tangent tan δ, the adhesion force of the isolated toner to the fixing member can be further reduced, and peelability from the fixing member can be further increased. As a result, the non-visual offset is suppressed, and the end part of the recording medium is less likely to be stained.

From the above, with the above-described configuration, it is presumed that the toner according to the present exemplary embodiment can suppress end part stains of a recording medium while having low-temperature fixability.

Hereinafter, the toner according to the present exemplary embodiment will be described in detail.

The toner according to the present exemplary embodiment has toner particles and an external additive.

### Dynamic Viscoelasticity of Toner Particle

In the dynamic viscoelasticity measurement of the toner particles in a case where the temperature is raised from 30° C. to 120° C., the minimal value tan δ(min) of the loss tangent is present at 50° C. or higher and 80° C. or lower and is 0.50 or more and 1.00 or less, for example, preferably 0.60 or more and 0.90 or less, and more preferably 0.70 or more and 0.90 or less.

In a case where the minimal value tan δ(min) of the loss tangent is less than 0.50, the viscoelasticity of the toner during melting is viscous, the adhesion force of the isolated toner to the fixing member is increased, and the peelability from the fixing member is decreased. As a result, the non-visual offset occurs, and the end part stains of the recording medium occur.

In a case where the minimal value tan δ(min) of the loss tangent is more than 1.00, the viscoelasticity of the toner during melting is excessively elastic, and the low-temperature fixability is deteriorated.

In the toner particles, a ratio tan δ(90)/tan δ(min) of a loss tangent tan δ(90) at a temperature of 90° C. and the minimal value tan δ(min) of the loss tangent is, for example, preferably 2.5 or less, more preferably 2.2 or less, and still more preferably 2.0 or less.

In a case where the ratio tan δ(90)/tan δ(min) is 2.5 or less, even in a case where a method of receiving heat during the fixing is non-uniform due to paper unevenness, the adhesion force of the isolated toner to the fixing member can be suppressed, and thus the occurrence of non-visual offset can be suppressed.

Therefore, in a case where the ratio tan δ(90)/tan δ(min) is within the above-described range, the low-temperature fixability is enhanced, and the end part stains of the recording medium are easily suppressed.

Examples of a method of setting the minimal value tan δ(min) of the loss tangent and the ratio tan δ(90)/tan δ(min) to the above-described ranges include 1) a method of internally adding internally-added crosslinked resin particles (particularly, internally-added crosslinked resin particles having a specific glass transition temperature) to the toner particles, and 2) a method of adjusting an amount of one or more metal ions selected from the group consisting of Al, Mg, and Ca in the toner particles and controlling the amount of crosslinking of the binder resin by the metal ions.

The loss tangent tan δ of the toner particles is obtained by a dynamic viscoelasticity measurement in a case where the temperature is raised from 30° C. to 120° C. Specifically, the glass transition temperatures are obtained as follows.

A measurement sample is produced by molding the toner particles to be measured into a tablet type at room temperature (25° C.) using a press molding machine. The measurement sample is set in a rheometer and left at 120° C. for 20 minutes. Thereafter, the measurement sample is cooled to 60° C., retained at 60° C. for 1 hour, and then cooled to room temperature, and dynamic viscoelasticity measured under the following measurement conditions. Each loss tangent tan δ is obtained from each curve of the storage elastic modulus and the loss elastic modulus obtained by the measurement.

### Measurement Conditions

Measurement device: rheometer ARES (manufactured by TA Instruments)
Fixture: 8 mm parallel plates
Gap: adjusted to 3 mm
Frequency: 6.28 rad/s
Temperature rising conditions: start temperature=30° C., end temperature=120° C., temperature rising rate=2° C./min

Since the loss tangent tan δ of the toner particles is not affected by the external additive, the dynamic viscoelasticity measurement may be performed on the toner to measure each loss tangent tan δ.

### Configuration of Toner Particles

The toner particles contain an amorphous resin and a crystalline resin as a binder resin. The toner particles may contain a colorant, a release agent, internally-added crosslinked resin particles, and other additives.

In particular, for example, it is preferable that the toner particles contain the internally-added resin particles because the above-described loss tangent characteristics are easily obtained.

### Binder Resin

As the binder resin, an amorphous polyester resin and a crystalline resin are adopted as the binder resin.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

The amorphous polyester resin will be described.

The amorphous polyester resin is a condensate of a polycarboxylic acid and a polyhydric alcohol, that is, an amorphous polyester resin having a constitutional unit PC derived from a polyvalent carboxylic acid and a constitutional unit PA derived from a polyhydric alcohol.

The amorphous polyester resin includes, as a part of the constitutional unit PC derived from a polyvalent carboxylic acid and the constitutional unit PA derived from a polyhydric alcohol, a polyester resin (S) having at least one of a constitutional unit derived from an aliphatic dicarboxylic acid represented by Structural Formula (A) or a constitutional unit derived from an aliphatic diol represented by Structural Formula (B).

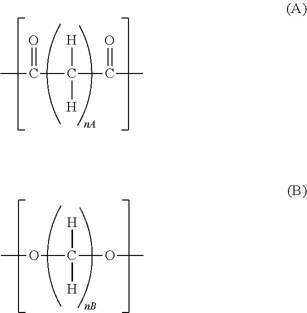

In Structural formulae (A) and (B), nA and nB each independently represent an integer of 2 or more and 12 or less.

The proportion of the total of the constitutional unit derived from the aliphatic dicarboxylic acid represented by Structural formula (A) and the constitutional unit derived from the aliphatic diol represented by Structural formula (B) with respect to all constitutional units constituting the entire amorphous polyester resin of the toner particles is 0.5% or more and 10.0% or less in terms of molar ratio, for example, preferably 1.5% or more and 8.0 or less, and more preferably 2.5% or more and 6.0% or less.

In a case where the proportion of the total of the constitutional units is less than 0.5%, the number of relatively flexible portions imparted to the inside of the toner particles is reduced, and the toner particles are less likely to be deformed in response to pressure applied during fixing. In this case, the non-visual offset cannot be suppressed, and the end part of the recording medium is stained. In addition, the affinity with the crystalline resin is also lowered, and the low-temperature fixability is deteriorated.

In a case where the proportion of the total of the constitutional units is 10.00% or more, the number of relatively flexible portions imparted to the inside of the toner particles is excessively increased, and thus the adhesiveness to the fixing member is increased and causes the non-visual offset.

The proportion of the total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is measured as follows.

The toner is dissolved in a solvent in which the binder resin is soluble, for example, in tetrahydrofuran (THF), and then insoluble components are removed and dried. In addition, the amorphous polyester resin and the crystalline resin included in the binder resin are separated using a solvent in which the amorphous polyester resin is soluble and the crystalline resin is insoluble, by utilizing a difference in solubility of the amorphous polyester resin and the crystalline resin in the solvent. After confirming that there is no endothermic peak derived from the crystalline resin in the obtained amorphous polyester resin using a differential scanning calorimeter (DSC), ¹H-NMR measurement is performed. The obtained NMR spectrum is analyzed to obtain a chemical shift and an integral value ratio, and from the chemical shift and the integral value ratio, the proportion (molar ratio) of the total of the constitutional unit derived from the aliphatic dicarboxylic acid represented by Structural formula (A) and the constitutional unit derived from the aliphatic diol represented by Structural formula (B) in the amorphous polyester resin is obtained.

From the viewpoint of easy availability and cost reduction, the amorphous polyester resin (S) is, for example, preferably a resin having only the constitutional unit derived from the aliphatic dicarboxylic acid represented by Structural Formula (A) among the constitutional unit derived from the aliphatic dicarboxylic acid represented by Structural Formula (A) and the constitutional unit derived from the aliphatic diol represented by Structural Formula (B).

A proportion of the constitutional unit derived from the aliphatic dicarboxylic acid represented by Structural formula (A) with respect to all constitutional units derived from dicarboxylic acid constituting the entire amorphous polyester resin of the toner particles is, for example, preferably 2.0% or more and 15.0% or less, more preferably 3.0% or more and 10.0% or less, and still more preferably 3.2% or more and 9.5% or less in terms of molar ratio.

In a case where the proportion of the constitutional unit derived from the aliphatic dicarboxylic acid represented by Structural Formula (A) is 2.0% or more, the toner particles are likely to be deformed in response to pressure applied during fixing due to the relatively flexible portions imparted to the inside of the toner particles. In this case, the non-visual offset cannot be suppressed, and the end part of the recording medium is stained. In addition, the affinity with the crystalline resin is also increased, and the low-temperature fixability is improved.

In a case where the proportion of the constitutional unit derived from the aliphatic dicarboxylic acid represented by Structural Formula (A) is 15.0% or less, the excessive decrease in the glass transition temperature Tg of the toner particles is suppressed without excessively increasing the relatively flexible portions imparted to the inside of the toner particles. As a result, excessive melting of the toner particles during the fixing is suppressed, and the low-temperature fixability is improved.

The proportion of the constitutional unit derived from the aliphatic dicarboxylic acid represented by Structural Formula (A) is measured as follows.

The toner is dissolved in a solvent in which the binder resin is soluble, for example, in tetrahydrofuran (THF), and then insoluble components are removed and dried. In addition, the amorphous polyester resin and the crystalline resin included in the binder resin are separated using a solvent in which the amorphous polyester resin is soluble and the crystalline resin is insoluble, by utilizing a difference in solubility of the amorphous polyester resin and the crystalline resin in the solvent. After confirming that there is no endothermic peak derived from the crystalline resin in the obtained amorphous polyester resin using a differential scanning calorimeter (DSC), ¹H-NMR measurement is performed. The obtained NMR spectrum is analyzed to obtain a chemical shift and an integral value ratio, and from the chemical shift and the integral value ratio, the proportion (molar ratio) of the constitutional unit derived from the aliphatic dicarboxylic acid represented by Structural formula (A) in the entire amorphous polyester resin is obtained.

In the amorphous polyester resin (S), from the viewpoint of low-temperature fixability and suppression of end part stains of the recording medium, the constitutional unit PA derived from a polyvalent carboxylic acid and the constitutional unit PC derived from a polyhydric alcohol, that are other than the constitutional unit derived from the aliphatic dicarboxylic acid represented by Structural formula (A) and the constitutional unit derived from the aliphatic diol represented by Structural formula (B), are each, for example, preferably a constitutional unit PA derived from an aromatic polyvalent carboxylic acid and a constitutional unit PC derived from an aromatic polyhydric alcohol.

Specifically, from the viewpoint of low-temperature fixability and suppression of end part stains of the recording medium, the amorphous polyester resin (S) is, for example, preferably a resin having the constitutional unit derived from the aliphatic dicarboxylic acid represented by Structural Formula (A), the constitutional unit derived from the aliphatic diol represented by Structural Formula (B), and a constitutional unit derived from an aromatic polyvalent carboxylic acid; and particularly preferably a resin having the constitutional unit derived from the aliphatic dicarboxylic acid represented by Structural Formula (A), the constitutional unit derived from the aliphatic diol represented by Structural Formula (B), a constitutional unit derived from terephthalic acid, and a constitutional unit derived from an aromatic polyhydric alcohol.

Examples of the aliphatic dicarboxylic acid represented by Structural Formula (A) include succinic acid, glutaric acid, adipic acid, pimelic acid, suberic acid, sebacic acid, azelaic acid, dodecanedioic acid, and anhydrides thereof.

Examples of the aromatic polyvalent carboxylic acid include terephthalic acid, isophthalic acid, orthophthalic acid, naphthalenedicarboxylic acid, anhydrides thereof, and lower (for example, 1 to 5 carbon atoms) alkyl esters thereof.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the aliphatic diol represented by Structural Formula (B) include ethylene glycol, butanediol, pentanediol, hexanediol, heptanediol, octanediol, nonanediol, decanediol, and undecane diol.

Examples of the aromatic polyhydric alcohol include an ethylene oxide adduct of bisphenol A and a propylene oxide adduct of bisphenol A.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the principle component.

Here, one kind of amorphous polyester resin may be used alone, or two or more kinds of amorphous polyester resins may be used in combination.

For example, it is preferable that the amorphous polyester resin obtained by using two or more kinds of amorphous polyester resins having different molecular weights in combination. Examples of the case of using two kinds in combination include a case of using a low-molecular-weight form (L form) of the amorphous polyester resin and a high-molecular-weight form (H form) of the amorphous polyester resin in combination.

The low-molecular-weight form (L form) is, for example, preferably an amorphous polyester resin having a weight-average molecular weight of 9,000 or more and 20,000 or less, which is measured by GPC. In a case where the molecular weight is less than 9,000, offset is likely to occur in a high-temperature portion; and in a case where the molecular weight is 20,000 or more, gloss is unlikely to be obtained in a low-temperature portion.

The high-molecular-weight form (H form) is, for example, preferably an amorphous polyester resin having a polymerization average molecular weight of 25,000 or more and 70,000 or less, which is measured by GPC. In a case where the molecular weight is 70,000 or more, gloss in a high-temperature portion is difficult to obtain, or a fixing temperature is increased.

An acid value of the amorphous polyester resin used in combination is, for example, preferably approximately 13 mgKOH/g or more and 20 mgKOH/g or less for the low-molecular-weight form (L form) and approximately 10 mgKOH/g or more and 15 mgKOH/g or less for the high-molecular-weight form (H form).

The crystalline resin will be described.

Examples of the crystalline resin include known crystalline resins such as a crystalline polyester resin, and a crystalline vinyl resin (such as a polyalkylene resin and a long-chain alkyl (meth)acrylate resin). Among these, from the viewpoint of ensuring the low-temperature fixability, for example, a crystalline polyester resin is preferable.

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

A content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

In addition, from the viewpoint of ensuring the low-temperature fixability and suppressing end part stains of the recording medium, a content of the crystalline resin with respect to the binder resin is, for example, preferably 2% by mass or more and 40% by mass or less, more preferably 5% by mass or more and 35% by mass or less, still more preferably 10% by mass or more and 30% by mass or less, and particularly preferably 15% by mass or more and 30% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Internally-Added Crosslinked Resin Particles

The internally-added crosslinked resin particles refer to resin particles that are contained inside the toner particles have a bridge structure between specific atoms in a polymer structure of the resin particles.

The internally-added crosslinked resin particles are, for example, particles that are present in the toner particles in a state of being incompatible with the binder resin.

Examples of the internally-added crosslinked resin particles include crosslinked resin particles crosslinked by an ionic bond (that is, ionically crosslinked resin particles), and crosslinked resin particles crosslinked by a covalent bond (that is, covalently crosslinked resin particles). Among these internally-added crosslinked resin particles, for example, crosslinked resin particles crosslinked by a covalent bond are preferable.

Examples of the type of the resin used for the internally-added crosslinked resin particles include a polyolefin-based resin (such as polyethylene and polypropylene), a styrene-based resin (such as polystyrene and α-polymethylstyrene), a (meth)acrylic resin (such as polymethyl methacrylate and polyacrylonitrile), an epoxy resin, a polyurethane resin, a polyurea resin, a polycarbonate resin, a polyether resin, a polyester resin, and copolymer resins of these compounds. As necessary, each of these resins may be used alone, or two or more of these resins may be used in combination.

Among the above resins, for example, a styrene-(meth)acrylic copolymer is contained as the resin used for the internally-added crosslinked resin particles. Specifically, the resin particles contain the styrene-(meth)acrylic copolymer as a main component in an amount of 50% by mass or more, for example, preferably 80% by mass or more and more preferably 90% by mass or more. In particular, for example, it is preferable that substantially all of the resin particles are the styrene-(meth)acrylic copolymer. In addition, the total of styrene-based monomer and (meth)acrylic monomer as monomers constituting the copolymer is, for example, preferably 80% by mass or more, more preferably 90% by mass or more, and particularly preferably 95% by mass or more. The remainder is a crosslinking agent described later.

Examples of the styrene-(meth)acrylic copolymer include a resin obtained by polymerizing the following styrene-based monomer and (meth)acrylic monomer by radical polymerization.

Examples of the styrene-based monomer include styrene, a-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylic monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, for example, n-butyl (meth)acrylate or 2-carboxyethyl (meth)acrylate is preferable.

In the internally-added crosslinked resin particles, examples of a crosslinking agent for crosslinking the resin include aromatic polyvalent vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy,1,3-diacryloxypropane; and polyvalent vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among these crosslinking agents, for example, it is preferable to use a bifunctional alkyl acrylate having an alkylene chain having 6 or more carbon atoms as the crosslinking agent for crosslinking the resin. That is, for example, the internally-added crosslinked resin particles preferably have a bifunctional alkyl acrylate as a constitutional unit, and the number of carbon atoms in the alkylene chain of the bifunctional alkyl acrylate is 6 or more.

By using internally-added crosslinked resin particles having the bifunctional alkyl acrylate as a constitutional unit, in which the number of carbon atoms in the alkylene chain is 6 or more, it is easy to obtain a toner in which the deformation of the toner during fixing is in an appropriate range, and in particular, a toner having favorable low-temperature fixability can be easily obtained. In a case where a crosslinking density of the internally-added crosslinked resin particles is high (that is, a distance between crosslinking points is short), elasticity is too high, but in a case where a bifunctional acrylate having a long alkylene chain is used as the crosslinking agent, the crosslinking density is low (that is, the distance between crosslinking points is long), and it is possible to prevent the elasticity of the internally-added crosslinked resin particles from being too high.

From the viewpoint of adjusting the crosslinking density to an appropriate range, the number of carbon atoms in the alkylene chain of the bifunctional alkyl acrylate is, for example, preferably 6 or more, more preferably 6 or more and 12 or less, and even more preferably 8 or more and 12 or less. More specific examples of the bifunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

Examples of other crosslinking agents include 2-carboxyethyl acrylate, and for example, it is preferable to use at least one of the above-described bifunctional alkyl acrylate or 2-carboxyethyl acrylate.

In a case where the internally-added crosslinked resin particles are polymer particles of a composition for forming resin particles containing a styrene-based monomer, a (meth)acrylic monomer, and a crosslinking agent, the amount of the crosslinking agent contained in the composition may be adjusted so that the fixability of the internally-added crosslinked resin particles is controlled. For example, by increasing the amount of the crosslinking agent contained in the composition, it is easy to obtain internally-added crosslinked resin particles having favorable fixability. The content of the crosslinking agent in the composition for forming the internally-added crosslinked resin particles with respect to the total of 100 parts by mass of the styrene-based monomer, the (meth)acrylic monomer, and the crosslinking agent is, for example, preferably 0.3 parts by mass or more and 5.0 parts by mass or less, more preferably 0.5 parts by mass or more and 3.0 parts by mass or less, and still more preferably 0.8 parts by mass or more and 2.5 parts by mass or less.

A glass transition temperature Tg of the internally-added crosslinked resin particles is, for example, preferably 0° C. or higher and 40° C. or lower, and more preferably 5° C. or higher and 35° C. or lower.

By setting the glass transition temperature Tg of the internally-added crosslinked resin particles to be within the above-described range, it is easy to control each loss tangent tan δ of the toner particles within the above-described ranges. As a result, the end part of the recording medium is less likely to be stained. In addition, the low-temperature fixability is improved.

The glass transition temperature Tg of the internally-added crosslinked resin particles is determined from a DSC curve obtained by differential scanning calorimetry (DSC). More specifically, the glass transition temperature Tg is determined by “extrapolated glass transition onset temperature” described in the method for determining a glass transition temperature in JIS K 7121-1987, “Testing methods for transition temperatures of plastics”.

The internally-added crosslinked resin particles can be extracted from the toner by dissolving the toner in a solvent in which the binder resin is soluble, for example, in tetrahydrofuran (THF), recovering insoluble components, and then drying the recovered matter.

In the internally-added crosslinked resin particles including the styrene-(meth)acrylic copolymer, the adjustment of Tg can be achieved by adjusting polymerization conditions of the copolymer.

A content of the internally-added crosslinked resin particles is, for example, preferably 2% by mass or more and 20% by mass or less, and more preferably 5% by mass or more and 15% by mass or less with respect to the entire toner.

In a case where the content of the internally-added crosslinked resin particles is within the above-described range, it is easy to control each loss tangent tan δ of the toner particles within the above-described range. As a result, the end part of the recording medium is less likely to be stained. In addition, the low-temperature fixability is improved.

An average dispersion size of the internally-added crosslinked resin particles is, for example, preferably 50 nm or more and 300 nm or less, more preferably 80 nm or more and 300 nm or less, and still more preferably 100 nm or more and 250 nm or less.

In a case where the average dispersion size of the internally-added crosslinked resin particles is within the above-described range, it is easy to control each loss tangent tan δ of the toner particles within the above-described range. As a result, the end part of the recording medium is less likely to be stained. In addition, the low-temperature fixability is improved.

A method of measuring the average dispersion size of the internally-added crosslinked resin particles is as follows.

The toner particles or the toner is mixed with and embedded in an epoxy resin, and the epoxy resin is solidified. The obtained solidified substance is cut with an ultramicrotome device (UltracutUCT manufactured by Leica Microsystems), thereby producing a thin sample having a thickness of 80 nm or more and 130 nm or less. Next, the obtained thin sample is dyed with ruthenium tetroxide in a desiccator at 30° C. for 3 hours. By using an ultra-high resolution field emission scanning electron microscope (FE-SEM, S-4800 manufactured by Hitachi High-Tech Corporation), an SEM image of dyed flake sample is obtained. Since ease of dyeing with ruthenium tetroxide varies in the order of the release agent, the styrene-(meth)acrylic resin, and the polyester resin, each component is identified by shade resulting from the degree of dyeing.

In a case where it is difficult to distinguish the light and shade due to the condition of the sample or the like, the staining time is adjusted.

In the cross section of the toner particles, the domain of the colorant is smaller than the domain of the release agent and the domain of the resin particles, so that the domains are distinguished by the size.

In the SEM image, 30 toner cross sections having a maximum length of 85% or more of the volume-average particle size of the toner particles are selected, and a total of 100 dyed internally-added crosslinked resin particles (that is, domains thereof) are observed. The maximum length of each domain is measured, the maximum length is regarded as the diameter of the domain, and the diameter is arithmetically averaged to obtain an average equivalent circle diameter. The obtained average equivalent circle diameter is defined as the average dispersion size of the internally-added crosslinked resin particles.

Examples of the adjustment of the average dispersion size of the internally-added crosslinked resin particles include a method of producing the toner particles by aggregation and coalescence and adjusting the volume-average particle size of the internally-added crosslinked resin particles contained in the specific resin particle dispersion used in production; and a method of controlling the average equivalent circle diameter by preparing a plurality of internally-added crosslinked resin particle dispersions with different volume-average particle sizes and using the specific resin particle dispersions in combination.

### Method for Producing Internally-Added Crosslinked Resin Particles

As a method for producing the internally-added crosslinked resin particles, for example, a known method such as an emulsion polymerization method, a melt-kneading method using a Banbury mixer or a kneader, a suspension polymerization method, and a spray drying method is adopted. For example, an emulsion polymerization method is preferable in order to unevenly distribute the units derived from the styrene-based monomer on the surface of the particles.

In the method for producing the internally-added crosslinked resin particles, for example, it is preferable to use a styrene-based monomer and a (meth)acrylic monomer as monomers and to carry out polymerization in the presence of a crosslinking agent.

In the method for producing the internally-added crosslinked resin particles, for example, it is preferable to perform emulsion polymerization a plurality of times.

Hereinafter, the method for producing the internally-added crosslinked resin particles will be described in more detail.

For example, it is preferable that the method for producing the internally-added crosslinked resin particles includes a step (emulsion preparation step) of obtaining an emulsion containing a monomer, a crosslinking agent, a surfactant, and water; a step (first emulsion polymerization step) of adding a polymerization initiator to the emulsion and then heating to polymerize the monomer; and a step (second emulsion polymerization step) of adding an emulsion containing a monomer and a crosslinking agent to the reaction solution after the first emulsion polymerization step, and then heating to polymerize the monomers.

Furthermore, in the second emulsion polymerization step, in order to adjust the composition of the surface of the particles, after preparing the emulsion by changing the ratio of the styrene-based monomer and the (meth)acrylic monomer, the emulsion may be added a plurality of times.

### Emulsion Preparation Step

The emulsion preparation step is a step of obtaining an emulsion containing a monomer, a crosslinking agent, a surfactant, and water.

For example, it is preferable to obtain the emulsion by emulsifying a monomer, a crosslinking agent, a surfactant, and water by using an emulsifying machine.

Examples of the emulsifying machine include a rotary stirrer equipped with a propeller type, anchor type, paddle type, or turbine type stirring blade; a stationary mixer such as a static mixer; a rotor and stator type emulsifying machine such as a homogenizer and Clare mix; a mill type emulsifying machine having grinding function; a high-pressure emulsifying machine such as a Manton-Gaulin-type pressure emulsifying machine; a high-pressure nozzle type emulsifying machine that causes cavitation under high pressure; a high-pressure impact-type emulsifying machine, such as a microfluidizer, that generates shearing force by causing collision of liquids under high pressure; an ultrasonic emulsifying machine that causes cavitation by using ultrasonic waves; and a membrane emulsifying machine that performs emulsification through pores.

As the monomers, for example, it is preferable to use a styrene-based monomer and a (meth)acrylic monomer.

As the crosslinking agent, the aforementioned crosslinking agent is used.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among these surfactants, for example, an anionic surfactant is preferable. One kind of surfactant may be used alone, or two or more kinds of surfactants may be used in combination.

The emulsion may contain a chain transfer agent. The chain transfer agent is not particularly limited. As the chain transfer agent, a compound having a thiol component can be used. Specifically, for example, alkyl mercaptans such as hexyl mercaptan, heptyl mercaptan, octyl mercaptan, nonyl mercaptan, decyl mercaptan, and dodecyl mercaptan are preferable.

A mass ratio of the styrene-based monomer to the (meth)acrylic monomer in the emulsion (styrene-based monomer/(meth)acrylic monomer) is, for example, preferably 0.2 or more and 1.1 or less.

In addition, the content of the crosslinking agent with respect to the entire emulsion is, for example, preferably 0.5% by mass or more and 3% by mass or less.

### First Emulsion Polymerization Step

The first emulsion polymerization step is a step of adding a polymerization initiator to the emulsion and heating the emulsion so as to polymerize the monomers.

Here, in the polymerization, for example, it is preferable to stir the emulsion (reaction solution) containing the polymerization initiator with a stirrer.

Examples of the stirrer include a rotary stirrer equipped with a propeller type, anchor type, paddle type, or turbine type stirring blade.

As the polymerization initiator, for example, it is preferable to use ammonium persulfate.

### Second Emulsion Polymerization Step

The second emulsion polymerization step is a step of adding an emulsion containing a monomer to the reaction solution obtained after the first emulsion polymerization step, and heating to polymerize the monomer.

In the polymerization, for example, it is preferable to stir the reaction solution in the same manner as in the first emulsion polymerization step.

In the present step, the ratio of the styrene-based monomer and the (meth)acrylic monomer in the emulsion containing the monomers may be changed, and the emulsion may be added by dividing the emulsion into a plurality of times.

For example, it is preferable to obtain the emulsion containing monomers by emulsifying monomers, a surfactant, and water by using an emulsifying machine.

### Other Additives

Examples of other additives include well-known additives such as a magnetic material, a charge control agent, and inorganic powder. The additives are incorporated into the toner particles as internal additives.

### Characteristics of Toner Particles and the Like

For example, the toner particles preferably contain one or more metal ions selected from the group consisting of Al, Mg, and Ca. A ratio AV1/M1 of an acid value AV1 of the binder resin to an amount M1 of the metal ions is, for example, preferably 1.0×10³ or more and 4.0×10³ or less, more preferably 1.5×10³ or more and 3.8×10³ or less, and still more preferably 2.0×10³ or more and 3.5×10³ or less.

By setting the ratio AV1/M1 to within in the above-described range, an appropriate crosslinking structure is imparted to the binder resin, and each loss tangent tan δ of the toner particles is easily controlled to be in the above-described range. As a result, the end part of the recording medium is less likely to be stained. In addition, the low-temperature fixability is improved.

The amount of the metal ions with respect to the toner particles is, for example, preferably 0.0015% by mass or more and 0.0150% by mass or less, and more preferably 0.0020% by mass or more and 0.0100% by mass or less.

Examples of a supply source of the metal ions (a compound contained in the toner particles as an additive) include a metal salt, an inorganic metal salt polymer, and a metal complex. In a case where the toner particles are produced by an aggregation and coalescence method, for example, the metal salt and the inorganic metal salt polymer are added to the toner particles as an aggregating agent.

Examples of the metal salt include aluminum sulfate, aluminum chloride, magnesium chloride, magnesium sulfate, calcium chloride, and calcium sulfate.

Examples of the inorganic metal salt polymer include polyaluminum chloride, polyaluminum hydroxide, and calcium polysulfide.

Examples of the metal complex include a metal salt of aminocarboxylic acid. Specific examples of the metal complex include metal salts (for example, a calcium salt, a magnesium salt, and an aluminum salt) based on a known chelate such as ethylenediaminetetraacetic acid, propanediaminetetraacetic acid, nitrilotriacetic acid, triethylenetetramine hexacetic acid, and diethylenetriaminepentaacetic acid.

These supply sources of the metal ions may be added as a simple additive, not for the purpose of the aggregating agent.

As the metal ion, for example, an Al ion is preferable. That is, as the supply source of the metal ions, for example, an aluminum salt (for example, aluminum sulfate, aluminum chloride, and the like) or an aluminum salt polymer (for example, polyaluminum chloride, polyaluminum hydroxide, and the like) is preferable. Among the supply sources of the metal ions, for example, an inorganic metal salt polymer is particularly preferable. Therefore, as the supply source of the metal ions, particularly, for example, an aluminum salt polymer (for example, polyaluminum chloride, polyaluminum hydroxide, and the like) is preferable.

The amount of the metal ions is measured by performing quantitative analysis of a fluorescence X-ray intensity of the toner particles. Specifically, for example, first, a resin and the supply source of the metal ions are mixed to obtain a resin mixture having a known concentration of the metal ions. A pellet sample is obtained by using a tablet press with a diameter of 13 mm for 200 mg of the resin mixture. A mass of the pellet sample is precisely weighed, and a fluorescence X-ray intensity of the pellet sample is measured to obtain a peak intensity. Similarly, the measurement is performed for the pellet samples in which the addition amount of the supply source of the metal ions is changed, and a calibration curve is created from these results. Next, the content of the metal ions in the toner particles to be measured is quantitatively analyzed using the calibration curve. In the present example, the metal ions are not limited to metals in a state of being ionized in the resin or in the toner particles, and refer to metal elements measured as the fluorescence X-ray intensity.

Examples of a method of adjusting the amount of the metal ions include 1) a method of adjusting the amount of the supply source of the metal ions added, and 2) a method of adjusting the amount of the metal ions by adding an aggregating agent (for example, the metal salt or the metal salt polymer) as the supply source of the metal ions in an aggregation step in a case where the toner particles are produced by an aggregation and coalescence method, adding a chelating agent (for example, ethylenediaminetetraacetic acid (EDTA), diethylenetriaminepentaacetic acid (DTPA), nitrilotriacetic acid (NTA), or the like) at the end of the aggregation step, forming a complex with the metal ions by the chelating agent, and removing a complex salt formed in a subsequent washing step or the like to adjust the content of the metal ions.

The acid value of the binder resin is measured based on “JIS K 0070-1992 Test Methods for Acid Value, Saponification Value, Ester Value, Iodine Value, Hydroxyl Value, and Unsaponifiable Value of Chemical Products”.

The binder resin component can be extracted from the toner by dissolving the toner in a solvent in which the binder resin is soluble, for example, in tetrahydrofuran (THF), removing insoluble components, and then drying the recovered matter.

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with the binder resin and other additives used as necessary, such as a colorant and a release agent, and a coating layer that is configured with the binder resin and the internally-added crosslinked resin particles.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 m. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-average particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-average particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include particles such as SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6.0% by mass or less.

### Manufacturing Method of Toner

Next, the manufacturing method of the toner according to the present exemplary embodiment will be described.

The toner according to the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by an aggregation and coalescence method, for example, the toner particles are manufactured through a step (first aggregated particle-forming step) of forming first aggregated particles by mixing a first amorphous resin particle dispersion in which first amorphous resin particles as a binder resin are dispersed, a crystalline resin particle dispersion in which crystalline resin particles as a binder resin are dispersed, an internally-added crosslinked resin particle dispersion in which internally-added crosslinked resin particles are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second amorphous resin particles as a binder resin to the first aggregated particle dispersion, and aggregating the second amorphous resin particles on a surface of the first aggregated particles; and a step (coalescence step) of heating the second aggregated particle dispersion in which the second aggregated particles are dispersed to allow the second aggregated particles to undergo coalescence and to form toner particles.

Here, as the first amorphous resin particles and the second amorphous resin particles, amorphous polyester resin particles are applied.

The present aggregation and coalescence method will be described as a method for producing toner particles containing a binder resin, a colorant, and a release agent; but the colorant and the release agent are components to be contained in the toner particles as necessary.

Hereinafter, each of the steps will be specifically described.

### Each Dispersion Preparing Step

First, each dispersion to be used in the aggregation and coalescence method is prepared. Specifically, the first amorphous resin particle dispersion in which first amorphous resin particles as a binder resin are dispersed, a crystalline resin particle dispersion in which crystalline resin particles are dispersed, an internally-added crosslinked resin particle dispersion in which internally-added crosslinked resin particles are dispersed, a colorant dispersion in which a colorant is dispersed, a second amorphous resin particle dispersion in which second amorphous resin particles as a binder resin are dispersed, and a release agent particle dispersion in which release agent particles are dispersed are prepared.

In each dispersion preparing step, the first amorphous resin particles, the second amorphous resin particles, and the crystalline resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, the colorant dispersion, the release agent particle dispersion, and the internally-added crosslinked resin particle dispersion are also prepared in the same manner as the resin particle dispersion. That is, the volume-average particle size of the particles, the dispersion medium, the dispersion method, and the content of the particles in the resin particle dispersion are also applied to the colorant to be dispersed in the colorant dispersion, the release agent particles to be dispersed in the release agent particle dispersion, and the internally-added crosslinked resin particles to be dispersed in the internally-added crosslinked resin particle dispersion.

### First Aggregated Particle-Forming Step

Next, the first amorphous resin particle dispersion, the crystalline resin particle dispersion, the internally-added crosslinked resin particle dispersion, the colorant dispersion, and the release agent particle dispersion are mixed with each other.

Next, in the mixed dispersion, the first amorphous resin particles, the crystalline resin particles, the internally-added crosslinked resin particles, the colorant, and the release agent particles are hetero-aggregated to form first aggregated particles containing the first amorphous resin, the internally-added crosslinked resin particles, the colorant, and the release agent particles.

Specifically, for example, an aggregating agent is added to a dispersion obtained by mixing the first amorphous resin particle dispersion, the crystalline resin particle dispersion, the internally-added crosslinked resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably 0.01 parts by mass or more and 5.0 parts by mass or less, and more preferably 0.1 parts by mass or more and less than 3.0 parts by mass with respect to 100 parts by mass of the resin particles (the first amorphous resin particles, the crystalline resin particles, and the internally-added crosslinked resin particles).

### Second Aggregated Particle-Forming Step

Next, after obtaining the first aggregated particle dispersion in which the first aggregated particles are dispersed, a second amorphous resin particle dispersion in which the second amorphous resin particles are dispersed is added to the first aggregated particle dispersion.

The second amorphous resin particles may be the same as or different from the first amorphous resin.

Next, the second amorphous resin particles are aggregated on the surface of the first aggregated particles in the dispersion of the first aggregated particles and the second amorphous resin particles. In this case, by further adding the release agent particle dispersion, the second amorphous resin particles and the release agent particles may be aggregated on the surface of the first aggregated particles. Specifically, for example, in the first aggregated particle-forming step, in a case where the first aggregated particles reach a target particle size, the second amorphous resin particle dispersion is added to the first aggregated particle dispersion, and the mixture is heated at a temperature equal to or lower than the glass transition temperature of the second amorphous resin particles.

By setting the pH of the dispersion in a range of, for example, about 6.5 or more and 8.5 or less, the progress of aggregation is stopped.

In this way, the second aggregated particles are obtained in which the second amorphous resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second amorphous resin particles by 10° C. to 30° C.) such that the second aggregated particles coalesce, thereby forming toner particles.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

In addition, in the second aggregated particle-forming step, a crystalline resin particle dispersion may be used, or an internally-added crosslinked resin particle dispersion may be used.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lodige mixer, or the like. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite.

Examples of the coating resin and the matrix resin include a styrene·(meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, more preferably contain 50% by mass or more of the (meth)acrylic resin with respect to the total mass of the resin, and still more preferably contain 80% by mass or more of the (meth)acrylic resin with respect to the total mass of the resin.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to be detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

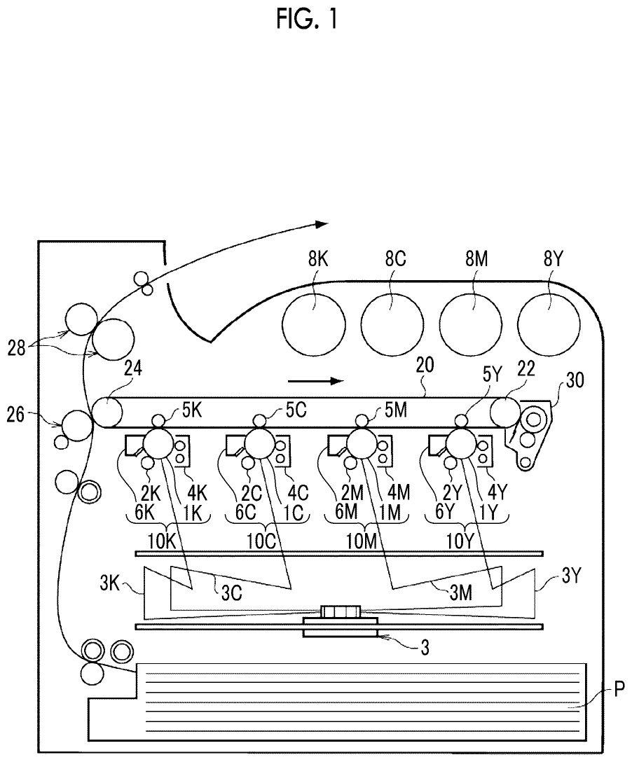

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor bY after the primary transfer are arranged in this order.

The primary transfer roll 5Y is disposed on the inner side of the intermediate transfer belt 20, at a position facing the photoreceptor bY. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 A under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

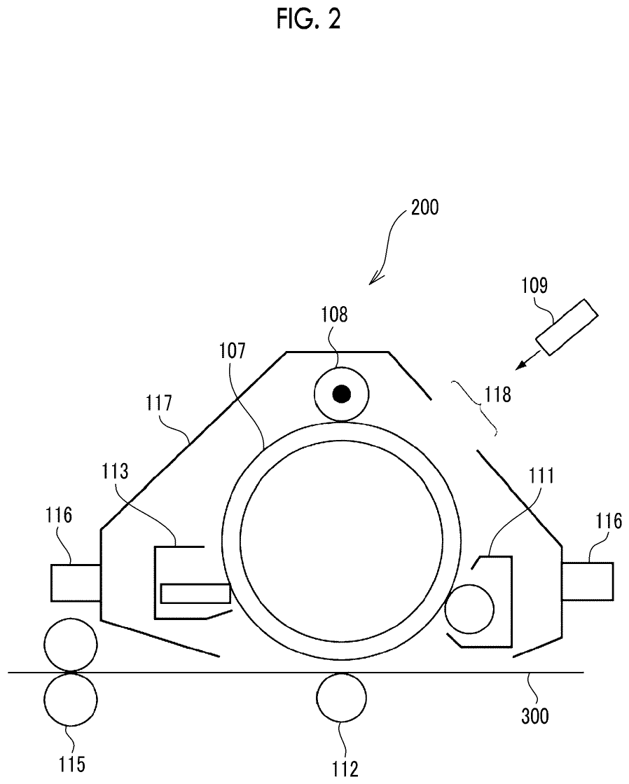

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Examples will be described below, but the present invention is not limited to these examples. In the following description, unless otherwise specified, “parts” and “%” are based on mass.

### Preparation of Emulsions (1-1) and (1-2)

### Emulsion (1-1)

Styrene: 80 parts
n-Butyl acrylate: 120 parts
1,10-Decanediol diacrylate (crosslinking agent): 4 parts
Anionic surfactant (NYUCOL 271A, manufactured by Nippon Nyukazai Co., Ltd.): 2.2 parts
Deionized water: 197.8 parts

The above-described materials are charged into a mixing vessel equipped with a stirrer, and stirred to prepare an emulsion (1-1).

### Emulsion (1-2)

Styrene: 75 parts
n-Butyl acrylate: 25 parts
1,10-Decanediol diacrylate (crosslinking agent): 1.0 part
Anionic surfactant (NYUCOL 271A): 1.1 parts
Deionized water: 97.7 parts

The above-described materials are charged into a mixing vessel equipped with a stirrer, and stirred to prepare an emulsion (1-2).

### Preparation of Internally-added Crosslinked Resin Particle Dispersion (1)

0.5 parts of an anionic surfactant (NYUCOL 271A) and 200 parts of deionized water are charged into a reaction vessel equipped with a stirrer and a nitrogen introduction tube, after replacing the inside of the reaction vessel with nitrogen. The reaction solution is heated in an oil bath while being stirred so that a temperature of the reaction solution is set to 65° C. After adding 10 parts of the emulsion (1-1) thereto, 10 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 65° C., 390 parts of the emulsion (1-1) is gradually added dropwise to the reaction vessel over 60 minutes by a pump. 200 parts of the emulsion (1-2) is further added dropwise thereto over 30 minutes.

After completion of the dropwise addition, the solution is retained for 60 minutes, 2 parts of ammonium persulfate having a concentration of 10% by mass is added thereto, and the mixture is retained for another 3 hours and then cooled to room temperature. Thereafter, deionized water is added thereto so that the concentration of solid contents is 20% by mass, thereby obtaining an internally-added crosslinked resin particle dispersion (1).

A volume-average particle size of the obtained resin particles is 165 nm. In addition, a glass transition temperature measured with a differential scanning calorimeter is 17° C.

### Preparation of Internally-Added Crosslinked Resin Particle Dispersions (2) to (7)

Internally-added crosslinked resin particle dispersions (2) to (7) are produced in the same manner as in the internally-added crosslinked resin particle dispersion (1), except that the conditions are changed as shown in Table 1.

### Preparation of Amorphous Polyester Resin Particle Dispersion (1)

Terephthalic acid: 25 parts by mole
Isophthalic acid: 19 parts by mole
Adipic acid: 3 parts by mole
Trimellitic anhydride: 2 parts by mole
Propylene oxide (2 mol) adduct of bisphenol A: 31 parts by mole
Propylene oxide (3 mol) adduct of bisphenol A: 20 parts by mole

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydrocondensation reaction is continued for 3 hours in the reaction solution retained at 240° C., and then the reactant is cooled to obtain an amorphous polyester resin (1).

The amorphous polyester resin (1) has an acid value of 10, a glass transition temperature of 61° C., and a weight-average molecular weight Mw of 25,000.
Amorphous polyester resin (1): 100 parts
Methyl ethyl ketone: 60 parts
Isopropanol: 10 parts
10% Aqueous ammonia solution: 3.5 parts

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (1) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the obtained dispersion, thereby obtaining an amorphous polyester resin particle dispersion (1) having a solid content of 20% by mass. A volume-average particle size of the amorphous polyester resin particles in the amorphous polyester resin particle dispersion (1) is 180 nm.

### Preparation of Amorphous Polyester Resin Particle Dispersions (2) to (19)

Amorphous polyester resin particle dispersions (2) to (19) are produced in the same manner as in the amorphous polyester resin particle dispersion (1), except that the conditions are changed as shown in Table 2.

Details of the abbreviations in Table 2 are as follows.
TPA: terephthalic acid
IPA: isophthalic acid
TMA: trimellitic anhydride
BPA-2PO: propylene oxide (2 mol) adduct of bisphenol A
BPA-3PO: propylene oxide (3 mol) adduct of bisphenol A
BPA-2EO: ethylene oxide (2 mol) adduct of bisphenol A
Structure A: monomer for forming the constitutional unit derived from the aliphatic dicarboxylic acid represented by Structural Formula (A) (that is, aliphatic dicarboxylic acid)
Structure B: monomer for forming the constitutional unit derived from the aliphatic diol represented by Structural Formula (B) (that is, aliphatic diol)

### Preparation of Crystalline Polyester Resin Particle Dispersion (1)

Dodecanedioic acid: 50 parts by mole
1,6-Hexanediol: 50 parts by mole

The above-described materials are charged into a reaction vessel equipped with a stirrer, a nitrogen introduction tube, a temperature sensor, and a rectifying column, the temperature is raised to 160° C. over 1 hour, and dibutyltin oxide is added to the mixture in an amount of 0.8 parts with respect to 100 parts of the above-described materials. While the generated water is distilled off, the temperature is raised to 180° C. for 6 hours, and while maintaining the temperature at 180° C. and stirring for 5 hours, the reaction is allowed to progress by refluxing in the container. Next, the temperature is slowly raised to 230° C. under reduced pressure (3 kPa), and the reaction solution is stirred for 2 hours in a state of being retained at 230° C. Subsequently, the reactant is cooled. After the cooling, solid-liquid separation is performed, and the solids are dried, thereby obtaining a crystalline polyester resin (1). The crystalline polyester resin (1) has an acid value of 8.8 and a weight-average molecular weight of 29,000.
Crystalline polyester resin (1): 100 parts
Methyl ethyl ketone: 70 parts
Isopropanol: 12 parts
10% Aqueous ammonia solution: 3 parts

The above-described materials are put in a jacketed reaction tank equipped with a condenser, a thermometer, a water dripping device, and an anchor blade, and in a state in which the reaction tank is retained at a liquid temperature of 80° C. in a water-circulation type thermostatic bath, the crystalline polyester resin (1) is dissolved while stirring and mixing the mixture at 100 rpm. Next, the water-circulation type thermostatic bath is set to 60° C., and a total of 300 parts of deionized water retained at 60° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the dispersion, thereby obtaining a crystalline polyester resin particle dispersion (1) having a solid content of 20% by mass. A volume-average particle size of the crystalline polyester resin particles in the crystalline polyester resin particle dispersion (1) is 160 nm.

### Preparation of Colorant Dispersion

Carbon black (Regel 330, manufactured by Cabot Corporation): 110 parts
Anionic surfactant (NEOPELEX G-65, Kao Corporation): 6 parts
Deionized water: 300 parts

The above-described materials are mixed together and dispersed for 10 minutes using a homogenizer (ULTRA-TURRAX T50, manufactured by IKA). Deionized water is added to the obtained dispersion, thereby obtaining a colorant dispersion having a solid content of 20% by mass. A volume-average particle size of the colorant particles in the colorant dispersion is 220 nm.

### Preparation of Release Agent Particle Dispersion

Fischer-Tropsch wax (Sasol wax H1, SASOL): 100 parts
Anionic surfactant (NEOPELEX G-65): 6 parts
Deionized water: 300 parts

The above-described materials are mixed together, heated to 100° C., and dispersed using a homogenizer (ULTRA-TURRAX T50). Furthermore, a dispersion treatment is performed using a Manton-Gaulin high-pressure homogenizer (manufactured by Gaulin Corporation), and deionized water is added to the dispersion, thereby obtaining a release agent particle dispersion having a solid content of 20% by mass.

A volume-average particle size of the release agent particles in the release agent particle dispersion is 230 nm.

### Example 1

### Production of Toner 1

Amorphous polyester resin particle dispersion (1) (solid content: 20% by mass): 61.7 parts
Internally-added crosslinked resin particle dispersion (1) (solid content: 20% by mass): 10 parts
Crystalline polyester resin particle dispersion (1) (solid content: 20% by mass): 15.4 parts
Colorant dispersion (solid content: 20% by mass): 6.9 parts
Release agent particle dispersion (solid content: 20% by mass): 6 parts
Anionic surfactant (ELEMINOL MON-2): 1.6 parts
Deionized water: 80 parts

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N nitric acid aqueous solution is added thereto such that the pH is adjusted to 5.0, and then 12 parts of 1% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 29 parts of the amorphous polyester resin particle dispersion (1) is added thereto, and the mixture is retained for 30 minutes. Next, 0.62 parts of CHELEST 40 (manufactured by Chelest Corporation, content: 40%) is added thereto. Thereafter, a 0.1N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (1) having a volume-average particle size of 5.5 m. 100 parts of the toner particles (1) and 2.0 parts of hydrophobic silica (manufactured by Nippon Aerosil Co., Ltd.; product name: RY200) are mixed with a Henshell mixer to obtain a toner 1.

### Examples 2 to 38 and Comparative Examples 1 to 6

### Production of Toners 2 to 38 and Toners C1 to C6

Toners 2 to 38 and toners C1 to C6 are obtained in the same manner as in the production of the toner 1, except that the type and amount of each resin particle dispersion added are changed as shown in Table 3. The solid content of each resin particle dispersion is set to 20% by mass.

The additional added amorphous polyester resin particle dispersion is also changed as shown in Table 3.

The following items of the toners obtained in Examples 1 to 38 and Comparative Examples 1 to 6 are shown. The methods for measuring the characteristics of the toner are as described above.
Minimal value tan δ(min) of the loss tangent of the toner particles at 50° C. or higher and 80° C. or lower
Loss tangent tan δ(90) of the toner particles at a temperature of 90° C.
Proportion of the total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin (described as “Proportion of structures A+B”)
Proportion of the constitutional unit derived from the aliphatic dicarboxylic acid represented by Structural formula (A) with respect to all constitutional units derived from dicarboxylic acid constituting the entire amorphous polyester resin (described as “Proportion of structure A”)
Content of the crystalline resin with respect to the binder resin
Glass transition temperature Tg of the internally-added crosslinked resin particles
Amount M1 of one or more metal ions selected from the group consisting of Al, Mg, and Ca in the toner particles
Ratio AV1/M1 of the acid value AV1 of the binder resin to the amount M1 of the metal ions

### Evaluation

### Production of Developer

8 parts of each toner obtained in each example and 92 parts of the following carrier are mixed to obtain a developer. The obtained developer is used for the evaluations described below.

### Production of Carrier

Ferrite particles (average particle size: 35 m): 100 parts
Toluene: 14 parts
Styrene/methyl methacrylate copolymer (copolymerization ratio: 15/85)
   3 parts
Carbon black: 0.2 parts

The above-described components excluding the ferrite particles are dispersed with a sand mill, thereby preparing a dispersion. The dispersion is put in a vacuum deaerating kneader together with the ferrite particles, and dried under reduced pressure while being stirred, thereby obtaining a carrier.

### Low-temperature Fixability

A developing device of a color copy machine Apeos C6570 (manufactured by FUJIFILM Business Innovation Corp.) from which a fixing device has been detached is filled with the obtained developer, a toner application amount is adjusted to 9.0 g/cm², and an unfixed image is printed out. Coletech 90 paper (manufactured by Xerox Corporation, basis weight: 90 gsm) is used as a recording medium. The image printed out is an image having a size of 50 mm×50 mm and an image density of 100%.

Thereafter, an unfixed image is fixed by a fixing evaluation device, and the low-temperature fixability is evaluated. As a fixing device, a modified device in which a fixer of Apeos C6570 manufactured by FUJIFILM Business Innovation Corp. is detached and the fixing temperature can be changed is used. The fixing temperature is raised from 120° C. to 190° C. in increments of 5° C., and the temperature at which image defect due to offset (phenomenon in which the toner adheres to the fixing member due to excessively insufficient melting of the toner) does not occur is defined as the minimum fixing temperature, and the low-temperature fixability is evaluated and classified as follows.
A: minimum fixing temperature is 145° C. or lower.
B: minimum fixing temperature is higher than 145° C. and 155° C. or lower.
C: minimum fixing temperature is higher than 155° C. and 165° C. or lower.
D: minimum fixing temperature is higher than 165° C.

### End Part Stains of Recording Medium

Each produced developer is filled in a developing device of a color copier Apeos C6570 (manufactured by FUJIFILM Business Innovation Corp.) as an image evaluation device.

Using an image evaluation device, 50,000 sheets of A3 Business 80 paper are continuously printed under the condition of 10° C. and 15% with a full halftone image having an image density of 50%, and the last 1,000 printed sheets are stacked. Thereafter, using a reflection densitometer (Xrite-939; manufactured by X-Rite Inc.), a reflection density of 20 points on the side surface of the end part of the stacked paper are measured. 1,000 sheets of paper before printing are stacked, and the density of the side surface of the end part of the stacked paper is measured in the same manner as described above, and the difference in density before and after the printing is evaluated as end part stains of the recording medium. The evaluation standard is as follows.
A+: maximum value and average value of 20 points are both less than 0.01.
A: maximum value of 20 points is 0.01 or more and less than 0.02, and an average value thereof is less than 0.01.
B: maximum value of 20 points is 0.02 or more and less than 0.04, and an average value thereof is less than 0.02.
C: maximum value of 20 points is 0.04 or more, and an average value thereof is less than 0.04.
D: maximum value and average value of 20 points are both 0.04 or more.

TABLE 1

| | Emulsion 1-1 | | | | | |
|---|---|---|---|---|---|---|
| | | | | | Anionic | |
| | | | | | surfactant | |
| | | | | | (NYUCOL 271A; | |
| | | | | | manufactured | |
| | | | | Amount of | by Nippon | |
| | | n-Butyl | Type of | crosslinking | Nyukazai | Emulsion 1-2 |
| | Styrene | acrylate | crosslinking | agent | Co., Ltd.) | Styrene |
| No. | [part] | [part] | agent | [part] | [part] | [part] |
| Internally-added | 80 | 120 | 1,10- | 4 | 2.2 | 75 |
| crosslinked resin | | | Decanediol | | | |
| particles 1 | | | diacrylate | | | |
| Internally-added | 50 | 150 | 1,10- | 4 | 2.2 | 60 |
| crosslinked resin | | | Decanediol | | | |
| particles 2 | | | diacrylate | | | |
| Internally-added | 70 | 130 | 1,10- | 4 | 2.2 | 55 |
| crosslinked resin | | | Decanediol | | | |
| particles 3 | | | diacrylate | | | |
| Internally-added | 110 | 90 | 1,10- | 4 | 2.2 | 80 |
| crosslinked resin | | | Decanediol | | | |
| particles 4 | | | diacrylate | | | |
| Internally-added | 130 | 70 | 1,10- | 4 | 2.2 | 75 |
| crosslinked resin | | | Decanediol | | | |
| particles 5 | | | diacrylate | | | |
| Internally-added | 80 | 120 | 1,6-Hexanediol | 1 | 2.2 | 75 |
| crosslinked resin | | | | | | |
| particles 6 | | | | | | |
| Internally-added | 80 | 120 | Divinylbenzene | 4.5 | 2.2 | 75 |
| crosslinked resin | | | | | | |
| particles 7 | | | | | | |

| | Emulsion 1-2 | | | | | |
|---|---|---|---|---|---|---|
| | | | | Anionic | | |
| | | | | surfactant | | |
| | | | | (NYUCOL 271A; | | |
| | | | | manufactured | Characteristic | |
| | | | Amount of | by Nippon | value | |
| | n-Butyl | Type of | crosslinking | Nyukazai | Tg | Particle |
| | acrylate | crosslinking | agent | Co., Ltd.) | (DSC) | size |
| No. | [part] | agent | [part] | [part] | [° C.] | [nm] |
| Internally-added | 25 | 1,10- | 1 | 1.1 | 17 | 165 |
| crosslinked resin | | Decanediol | | | | |
| particles 1 | | diacrylate | | | | |
| Internally-added | 40 | 1,10 | 1 | 1.1 | −3 | 166 |
| crosslinked resin | | Decanediol | | | | |
| particles 2 | | diacrylate | | | | |
| Internally-added | 50 | 1,10- | 1 | 1.1 | 3 | 170 |
| crosslinked resin | | Decanediol | | | | |
| particles 3 | | diacrylate | | | | |
| Internally-added | 20 | 1,10 | 1 | 1.1 | 37 | 162 |
| crosslinked resin | | Decanediol | | | | |
| particles 4 | | diacrylate | | | | |
| Internally-added | 35 | 1,10 | 1 | 1.1 | 42 | 165 |
| crosslinked resin | | Decanediol | | | | |
| particles 5 | | diacrylate | | | | |
| Internally-added | 25 | 1,6-Hexanediol | 0.3 | 1.1 | 16 | 167 |
| crosslinked resin | | | | | | |
| particles 6 | | | | | | |
| Internally-added | 25 | Divinylbenzene | 2 | 1.1 | 17 | 169 |
| crosslinked resin | | | | | | |
| particles 7 | | | | | | |

TABLE 2

| | Acid | | | | | Alcohol | |
|---|---|---|---|---|---|---|---|
| | | Amount | | | | | Amount |
| | | of | | | | | of |
| | | structure | | | | | structure |
| | | A | TPA | IPA | TMA | | B |
| | Type of | [% by | [% by | [% by | [% by | Type of | [% by |
| No. | structure A | mole] | mole] | mole] | mole] | structure B | mole] |
| Amorphous PES | Adipic acid | 3 | 25 | 19 | 2 | — | 0 |
| resin particle | | | | | | | |
| dispersion 1 | | | | | | | |
| Amorphous PES | Adipic acid | 2 | 25 | 20 | 2 | 1,10- | 2 |
| resin particle | | | | | | Decanediol | |
| dispersion 2 | | | | | | | |
| Amorphous PES | Sebacic acid | 4 | 31 | 12 | 2 | 1,4- | 6 |
| resin particle | | | | | | Butanediol | |
| dispersion 3 | | | | | | | |
| Amorphous PES | Sebacic acid | 0.4 | 30 | 16.6 | 2 | 1,4- | 0.1 |
| resin particle | | | | | | Butanediol | |
| dispersion 4 | | | | | | | |
| Amorphous PES | Glutaric acid | 7.3 | 39.7 | 0 | 2 | — | 0 |
| resin particle | | | | | | | |
| dispersion 5 | | | | | | | |
| Amorphous PES | Dodecanedioic acid | 1 | 46 | 0 | 2 | — | 0 |
| resin particle | | | | | | | |
| dispersion 6 | | | | | | | |
| Amorphous PES | Glutaric acid | 7.5 | 39.5 | 0 | 2 | — | 0 |
| resin particle | | | | | | | |
| dispersion 7 | | | | | | | |
| Amorphous PES | Dodecanedioic acid | 0.8 | 46.2 | 0 | 2 | — | 0 |
| resin particle | | | | | | | |
| dispersion 8 | | | | | | | |
| Amorphous PES | Glutaric acid | 4.9 | 42.1 | 0 | 2 | — | 0 |
| resin particle | | | | | | | |
| dispersion 9 | | | | | | | |
| Amorphous PES | Dodecanedioic acid | 1.5 | 45.5 | 0 | 2 | — | 0 |
| resin particle | | | | | | | |
| dispersion 10 | | | | | | | |
| Amorphous PES | Adipic acid | 4 | 25 | 19 | 2 | — | 0 |
| resin particle | | | | | | | |
| dispersion 11 | | | | | | | |
| Amorphous PES | Adipic acid | 2 | 24 | 20 | 2 | 1,10- | 2 |
| resin particle | | | | | | Decanediol | |
| dispersion 12 | | | | | | | |
| Amorphous PES | — | 0 | 25 | 22 | 2 | — | 0 |
| resin particle | | | | | | | |
| dispersion 13 | | | | | | | |
| Amorphous PES | Sebacic acid | 5 | 30 | 12 | 2 | 1,4- | 6 |
| resin particle | | | | | | Butanediol | |
| dispersion 14 | | | | | | | |
| Amorphous PES | Sebacic acid | 0.2 | 30 | 16.8 | 2 | 1,4- | 0.2 |
| resin particle | | | | | | Butanediol | |
| dispersion 15 | | | | | | | |
| Amorphous PES | Adipic acid | 5 | 40 | 0 | 4 | — | 0 |
| resin particle | | | | | | | |
| dispersion 16 | | | | | | | |
| Amorphous PES | Adipic acid | 1 | 30 | 18 | 0 | — | 0 |
| resin particle | | | | | | | |
| dispersion 17 | | | | | | | |
| Amorphous PES | 1,14- | 0 | 40 | 5 | 2 | 1,14- | 0 |
| resin particle | Tetradecanedicarboxylic | | | | | Tetradecanediol | |
| dispersion 18 | acid | | | | | | |
| Amorphous PES | Adipic acid | 6 | 25 | 16 | 2 | — | 0 |
| resin particle | | | | | | | |
| dispersion 19 | | | | | | | |

| | | | | (Amount of | | | | |
|---|---|---|---|---|---|---|---|---|
| | | | | structure A + | | | | |
| | | | | amount of | Amount of | | | |
| | Alcohol | | | structure | structure | | | |
| | BPA- | BPA- | BPA- | B)/total | A/acid | | | |
| | 2PO | 3PO | 2EO | monomer | monomer | | | |
| | [% by | [% by | [% by | amount | amount | Acid | | |
| No. | mole] | mole] | mole] | [% by mole] | [% by mole] | value | Tg | Mw |
| Amorphous PES | 31 | 20 | | 3.0 | 6.1 | 10 | 61 | 25000 |
| resin particle | | | | | | | | |
| dispersion 1 | | | | | | | | |
| Amorphous PES | 10 | 29 | 10 | 4.0 | 4.1 | 10 | 61 | 28000 |
| resin particle | | | | | | | | |
| dispersion 2 | | | | | | | | |
| Amorphous PES | 19 | 24 | 2 | 10.0 | 8.2 | 10 | 57 | 30000 |
| resin particle | | | | | | | | |
| dispersion 3 | | | | | | | | |
| Amorphous PES | 30 | 20.9 | | 0.5 | 0.8 | 10 | 62 | 29000 |
| resin particle | | | | | | | | |
| dispersion 4 | | | | | | | | |
| Amorphous PES | 31 | 20 | | 7.3 | 14.9 | 10 | 58 | 33000 |
| resin particle | | | | | | | | |
| dispersion 5 | | | | | | | | |
| Amorphous PES | 31 | 20 | | 1.0 | 2.0 | 10 | 60 | 31000 |
| resin particle | | | | | | | | |
| dispersion 6 | | | | | | | | |
| Amorphous PES | 31 | 20 | | 7.5 | 15.3 | 10 | 56 | 32000 |
| resin particle | | | | | | | | |
| dispersion 7 | | | | | | | | |
| Amorphous PES | 31 | 20 | | 0.8 | 1.6 | 10 | 62 | 28000 |
| resin particle | | | | | | | | |
| dispersion 8 | | | | | | | | |
| Amorphous PES | 31 | 20 | | 4.9 | 10.0 | 10 | 59 | 34000 |
| resin particle | | | | | | | | |
| dispersion 9 | | | | | | | | |
| Amorphous PES | 31 | 20 | | 1.5 | 3.1 | 10 | 60 | 33000 |
| resin particle | | | | | | | | |
| dispersion 10 | | | | | | | | |
| Amorphous PES | 30 | 20 | | 4.0 | 8.0 | 14 | 60 | 26000 |
| resin particle | | | | | | | | |
| dispersion 11 | | | | | | | | |
| Amorphous PES | 10 | 30 | 10 | 4.0 | 4.2 | 7 | 60 | 24000 |
| resin particle | | | | | | | | |
| dispersion 12 | | | | | | | | |
| Amorphous PES | 31 | 20 | | 0.0 | 0.0 | 10 | 62 | 28000 |
| resin particle | | | | | | | | |
| dispersion 13 | | | | | | | | |
| Amorphous PES | 20 | 21 | 4 | 11.0 | 10.2 | 10 | 58 | 25000 |
| resin particle | | | | | | | | |
| dispersion 14 | | | | | | | | |
| Amorphous PES | 30 | 20.8 | | 0.40 | 0.4 | 10 | 62 | 31000 |
| resin particle | | | | | | | | |
| dispersion 15 | | | | | | | | |
| Amorphous PES | 20 | 31 | | 5.0 | 10.2 | 10 | 60 | 58000 |
| resin particle | | | | | | | | |
| dispersion 16 | | | | | | | | |
| Amorphous PES | 10 | 41 | | 1.0 | 2.0 | 10 | 61 | 13000 |
| resin particle | | | | | | | | |
| dispersion 17 | | | | | | | | |
| Amorphous PES | 0 | 34 | 15 | 0.0 | 0.0 | 10 | 56 | 30000 |
| resin particle | | | | | | | | |
| dispersion 18 | | | | | | | | |
| Amorphous PES | 31 | 20 | | 6.0 | 12.2 | 10 | 57 | 24000 |
| resin particle | | | | | | | | |
| dispersion 19 | | | | | | | | |

TABLE 3-1

| | Toner manufacturing condition | | | | | | | | |
|---|---|---|---|---|---|---|---|---|---|
| | Charging | | | | | | | | |
| | Amorphous PES resin | | Crystalline PES resin | | Internally-added crosslinked | | | | |
| | particle dispersion | | particle dispersion | | resin particle dispersion | | Aggregating agent | | CHELEST 40 |
| | | Amount | | Amount | | Amount | | Amount | Amount |
| | Type | (part amount) | Type | (part amount) | Type | (part amount) | Type | (part amount) | (part amount) |
| Example 1 | 1 | 61.7 | 1 | 15.4 | 1 | 10 | 1% Al sulfate | 12 | 0.62 |
| | | | | | | | aqueous solution | | |
| Example 2 | 2 | 61.7 | 1 | 15.4 | 1 | 10 | 1% Al sulfate | 12 | 0.62 |
| | | | | | | | aqueous solution | | |
| Example 3 | 3 | 69.8 | 1 | 12.3 | 6 | 5 | 1% Al sulfate | 12 | 0.62 |
| | | | | | | | aqueous solution | | |
| Example 4 | 1 | 60.1 | 1 | 17.0 | 7 | 10 | 1% Al sulfate | 12 | 0.62 |
| | | | | | | | aqueous solution | | |
| Example 5 | 1 | 63.2 | 1 | 13.9 | 6 | 10 | 1% Al sulfate | 12 | 0.62 |
| | | | | | | | aqueous solution | | |
| Example 6 | 1 | 57.7 | 1 | 14.4 | 7 | 15 | 1% Al sulfate | 12 | 0.62 |
| | | | | | | | aqueous solution | | |
| Example 7 | 4 | 61.7 | 1 | 15.4 | 1 | 10 | 1% Al sulfate | 12 | 0.62 |
| | | | | | | | aqueous solution | | |
| Example 8 | 3 | 61.7 | 1 | 15.4 | 1 | 10 | 1% Al sulfate | 12 | 0.62 |
| | | | | | | | aqueous solution | | |
| Example 9 | 8 | 61.7 | 1 | 15.4 | 1 | 10 | 1% Al sulfate | 12 | 0.62 |
| | | | | | | | aqueous solution | | |
| Example 10 | 6 | 61.7 | 1 | 15.4 | 1 | 10 | 1% Al sulfate | 12 | 0.62 |
| | | | | | | | aqueous solution | | |
| Example 11 | 10 | 61.7 | 1 | 15.4 | 1 | 10 | 1% Al sulfate | 12 | 0.62 |
| | | | | | | | aqueous solution | | |
| Example 12 | 9 | 61.7 | 1 | 15.4 | 1 | 10 | 1% Al sulfate | 12 | 0.62 |
| | | | | | | | aqueous solution | | |
| Example 13 | 5 | 61.7 | 1 | 15.4 | 1 | 10 | 1% Al sulfate | 12 | 0.62 |
| | | | | | | | aqueous solution | | |
| Example 14 | 7 | 61.7 | 1 | 15.4 | 1 | 10 | 1% Al sulfate | 12 | 0.62 |
| | | | | | | | aqueous solution | | |
| Example 15 | 1 | 61.7 | 1 | 15.4 | 6 | 10 | 1% Al sulfate | 12 | 0.74 |
| | | | | | | | aqueous solution | | |
| Example 16 | 1 | 54.1 | 1 | 18.0 | 6 | 7 | 1% Al sulfate | 12 | 0.74 |
| | | | | | | | aqueous solution | | |
| Example 17 | 1 | 61.7 | 1 | 15.4 | 2 | 10 | 1% Al sulfate | 12 | 0.62 |
| | | | | | | | aqueous solution | | |
| Example 18 | 1 | 61.7 | 1 | 15.4 | 3 | 10 | 1% Al sulfate | 12 | 0.62 |
| | | | | | | | aqueous solution | | |
| Example 19 | 1 | 61.7 | 1 | 15.4 | 4 | 10 | 1% Al sulfate | 12 | 0.62 |
| | | | | | | | aqueous solution | | |
| Example 20 | 1 | 61.7 | 1 | 15.4 | 5 | 10 | 1% Al sulfate | 12 | 0.62 |
| | | | | | | | aqueous solution | | |
| Example 21 | 1 | 70.9 | 1 | 6.2 | 1 | 10 | 1% Al sulfate | 12 | 0.62 |
| | | | | | | | aqueous solution | | |
| Example 22 | 1 | 54.0 | 1 | 23.1 | 1 | 10 | 1% Al sulfate | 12 | 0.62 |
| | | | | | | | aqueous solution | | |
| Example 23 | 1 | 69.4 | 1 | 7.7 | 1 | 10 | 1% Al sulfate | 12 | 0.62 |
| | | | | | | | aqueous solution | | |
| Example 24 | 1 | 51.7 | 1 | 25.4 | 1 | 10 | 1% Al sulfate | 12 | 0.62 |
| | | | | | | | aqueous solution | | |
| Example 25 | 12 | 61.7 | 1 | 15.4 | 1 | 10 | 1% Al sulfate | 12 | 0.43 |
| | | | | | | | aqueous solution | | |
| Example 26 | 12 | 61.7 | 1 | 15.4 | 1 | 10 | 1% Al sulfate | 12 | 0.62 |
| | | | | | | | aqueous solution | | |
| Example 27 | 12 | 61.7 | 1 | 15.4 | 1 | 10 | 1% Al sulfate | 12 | 0.78 |
| | | | | | | | aqueous solution | | |
| Example 28 | 12 | 61.7 | 1 | 15.4 | 1 | 10 | 1% Al sulfate | 12 | 0.88 |
| | | | | | | | aqueous solution | | |
| Example 29 | 11 | 61.7 | 1 | 15.4 | 1 | 10 | 1% Al sulfate | 12 | 0.38 |
| | | | | | | | aqueous solution | | |
| Example 30 | 11 | 61.7 | 1 | 15.4 | 1 | 10 | 1% Al sulfate | 12 | 0.40 |
| | | | | | | | aqueous solution | | |
| Example 31 | 11 | 61.7 | 1 | 15.4 | 1 | 10 | 1% Al sulfate | 12 | 0.51 |
| | | | | | | | aqueous solution | | |
| Example 32 | 11 | 61.7 | 1 | 15.4 | 1 | 10 | 1% Al sulfate | 12 | 0.62 |
| | | | | | | | aqueous solution | | |
| Example 33 | 16 | 30.8 | 1 | 15.4 | 1 | 10 | 1% Al sulfate | 12 | 0.62 |
| | 17 | 30.8 | | | | | aqueous solution | | |
| Example 34 | 13 | 30.8 | 1 | 15.4 | 1 | 10 | 1% Al sulfate | 12 | 0.62 |
| | 19 | 30.8 | | | | | aqueous solution | | |
| Example 35 | 1 | 61.7 | 1 | 15.4 | 1 | 10 | 1% Mg chloride | 12 | 0.62 |
| | | | | | | | aqueous solution | | |
| Example 36 | 1 | 61.7 | 1 | 15.4 | 1 | 10 | 1% Ca chloride | 12 | 0.62 |
| | | | | | | | aqueous solution | | |
| Example 37 | 11 | 61.7 | 1 | 15.4 | 1 | 10 | 1% Al sulfate | 12 | 0.65 |
| | | | | | | | aqueous solution | | |
| Example 38 | 11 | 61.7 | 1 | 15.4 | 1 | 10 | 1% Al sulfate | 12 | 0.52 |
| | | | | | | | aqueous solution | | |
| Comparative | 13 | 61.7 | 1 | 15.4 | 1 | 10 | 1% Al sulfate | 12 | 0.62 |
| Example 1 | | | | | | | aqueous solution | | |
| Comparative | 14 | 61.7 | 1 | 15.4 | 1 | 10 | 1% Al sulfate | 12 | 0.62 |
| Example 2 | | | | | | | aqueous solution | | |
| Comparative | 1 | 69.8 | 1 | 12.3 | 6 | 5 | 1% Al sulfate | 12 | 0.93 |
| Example 3 | | | | | | | aqueous solution | | |
| Comparative | 1 | 57.7 | 1 | 14.4 | 7 | 15 | 1% Al sulfate | 12 | 0.74 |
| Example 4 | | | | | | | aqueous solution | | |
| Comparative | 18 | 61.7 | 1 | 15.4 | 1 | 10 | 1% Al sulfate | 12 | 0.62 |
| Example 5 | | | | | | | aqueous solution | | |
| Comparative | 15 | 61.7 | 1 | 15.4 | 1 | 10 | 1% Al sulfate | 12 | 0.62 |
| Example 6 | | | | | | | aqueous solution | | |

TABLE 3-2

| | Toner characteristics | | | |
|---|---|---|---|---|
| | | Amorphous PES resin | | Crystalline resin |
| | | Proportion of | Proportion of structure A | Content |
| | | structures A + B | (molar ratio with respect | (% by mass |
| | Binder resin | (molar ratio with | to all constitutional units | with respect |
| | Acid value AV1 | respect to all | derived from polyvalent | to binder |
| | (mgKOH/g) | constitutional units) | carboxylic acid) | resin) |
| Example 1 | 9.8 | 3.0 | 6.1 | 20 |
| Example 2 | 9.8 | 4.0 | 4.1 | 20 |
| Example 3 | 9.8 | 10.0 | 8.2 | 15 |
| Example 4 | 9.8 | 3.0 | 6.1 | 22 |
| Example 5 | 9.8 | 3.0 | 6.1 | 18 |
| Example 6 | 9.8 | 3.0 | 6.1 | 20 |
| Example 7 | 9.8 | 0.5 | 0.8 | 20 |
| Example 8 | 9.8 | 10.0 | 8.2 | 20 |
| Example 9 | 9.8 | 0.8 | 1.6 | 20 |
| Example 10 | 9.8 | 1.0 | 2.0 | 20 |
| Example 11 | 9.8 | 1.5 | 3.1 | 20 |
| Example 12 | 9.8 | 4.9 | 10.0 | 20 |
| Example 13 | 9.8 | 7.3 | 14.9 | 20 |
| Example 14 | 9.8 | 7.5 | 15.3 | 20 |
| Example 15 | 9.8 | 3.0 | 6.1 | 20 |
| Example 16 | 9.8 | 3.0 | 6.1 | 20 |
| Example 17 | 9.8 | 3.0 | 6.1 | 20 |
| Example 18 | 9.8 | 3.0 | 6.1 | 20 |
| Example 19 | 9.8 | 3.0 | 6.1 | 20 |
| Example 20 | 9.8 | 3.0 | 6.1 | 20 |
| Example 21 | 9.8 | 3.0 | 6.1 | 8 |
| Example 22 | 9.8 | 3.0 | 6.1 | 30 |
| Example 23 | 9.8 | 3.0 | 6.1 | 10 |
| Example 24 | 9.8 | 3.0 | 6.1 | 33 |
| Example 25 | 7.4 | 4.0 | 4.2 | 20 |
| Example 26 | 7.4 | 4.0 | 4.2 | 20 |
| Example 27 | 7.4 | 4.0 | 4.2 | 20 |
| Example 28 | 7.4 | 4.0 | 4.2 | 20 |
| Example 29 | 13.0 | 4.0 | 8.0 | 20 |
| Example 30 | 13.0 | 4.0 | 8.0 | 20 |
| Example 31 | 13.0 | 4.0 | 8.0 | 20 |
| Example 32 | 13.0 | 4.0 | 8.0 | 20 |
| Example 33 | 9.8 | 3.0 | 6.1 | 20 |
| Example 34 | 9.8 | 3.0 | 6.1 | 20 |
| Example 35 | 9.8 | 3.0 | 6.1 | 20 |
| Example 36 | 9.8 | 3.0 | 6.1 | 20 |
| Example 37 | 13.0 | 4.0 | 8.0 | 20 |
| Example 38 | 13.0 | 4.0 | 8.0 | 20 |
| Comparative | 9.8 | 0.0 | 0.0 | 20 |
| Example 1 | | | | |
| Comparative | 9.8 | 11.0 | 10.2 | 20 |
| Example 2 | | | | |
| Comparative | 9.8 | 3.0 | 6.1 | 15 |
| Example 3 | | | | |
| Comparative | 9.8 | 3.0 | 6.1 | 20 |
| Example 4 | | | | |
| Comparative | 9.8 | 0.0 | 0.0 | 20 |
| Example 5 | | | | |
| Comparative | 9.8 | 0.4 | 0.4 | 20 |
| Example 6 | | | | |

| | Toner characteristics | | | |
|---|---|---|---|---|
| | Internally-added | | Metal ion | |
| | crosslinked resin particles | | Amount of total | |
| | Content | | metal ions of Al, | |
| | (% by mass | | Mg, and Ca M1 | |
| | with respect | | (% by mass with | |
| | to toner | Tg | respect to toner | AV1/M1 |
| | particles) | (° C.) | particles) | [×10³] |
| Example 1 | 10 | 17 | 0.0030 | 3.3 |
| Example 2 | 10 | 17 | 0.0030 | 3.3 |
| Example 3 | 5 | 16 | 0.0030 | 3.3 |
| Example 4 | 10 | 17 | 0.0030 | 3.3 |
| Example 5 | 10 | 16 | 0.0030 | 3.3 |
| Example 6 | 15 | 17 | 0.0030 | 3.3 |
| Example 7 | 10 | 17 | 0.0030 | 3.3 |
| Example 8 | 10 | 17 | 0.0030 | 3.3 |
| Example 9 | 10 | 17 | 0.0030 | 3.3 |
| Example 10 | 10 | 17 | 0.0030 | 3.3 |
| Example 11 | 10 | 17 | 0.0030 | 3.3 |
| Example 12 | 10 | 17 | 0.0030 | 3.3 |
| Example 13 | 10 | 17 | 0.0030 | 3.3 |
| Example 14 | 10 | 17 | 0.0030 | 3.3 |
| Example 15 | 10 | 16 | 0.0025 | 3.9 |
| Example 16 | 7 | 16 | 0.0025 | 3.9 |
| Example 17 | 10 | −3 | 0.0030 | 3.3 |
| Example 18 | 10 | 3 | 0.0030 | 3.3 |
| Example 19 | 10 | 37 | 0.0030 | 3.3 |
| Example 20 | 10 | 42 | 0.0030 | 3.3 |
| Example 21 | 10 | 17 | 0.0030 | 3.3 |
| Example 22 | 10 | 17 | 0.0030 | 3.3 |
| Example 23 | 10 | 17 | 0.0030 | 3.3 |
| Example 24 | 10 | 17 | 0.0030 | 3.3 |
| Example 25 | 10 | 17 | 0.0080 | 0.9 |
| Example 26 | 10 | 17 | 0.0050 | 1.5 |
| Example 27 | 10 | 17 | 0.0021 | 3.5 |
| Example 28 | 10 | 17 | 0.0015 | 4.9 |
| Example 29 | 10 | 17 | 0.0150 | 0.9 |
| Example 30 | 10 | 17 | 0.0130 | 1.0 |
| Example 31 | 10 | 17 | 0.0060 | 2.2 |
| Example 32 | 10 | 17 | 0.0030 | 4.3 |
| Example 33 | 10 | 17 | 0.0030 | 3.3 |
| Example 34 | 10 | 17 | 0.0030 | 3.3 |
| Example 35 | 10 | 17 | 0.0030 | 3.3 |
| Example 36 | 10 | 17 | 0.0030 | 3.3 |
| Example 37 | 10 | 17 | 0.0033 | 3.9 |
| Example 38 | 10 | 17 | 0.0064 | 2.0 |
| Comparative | 10 | 17 | 0.0030 | 3.3 |
| Example 1 | | | | |
| Comparative | 10 | 17 | 0.0030 | 3.3 |
| Example 2 | | | | |
| Comparative | 5 | 16 | 0.0010 | 9.8 |
| Example 3 | | | | |
| Comparative | 15 | 17 | 0.0020 | 4.9 |
| Example 4 | | | | |
| Comparative | 10 | 17 | 0.0030 | 3.3 |
| Example 5 | | | | |
| Comparative | 10 | 17 | 0.0030 | 3.3 |
| Example 6 | | | | |

TABLE 3-3

| | | | | Evaluation | |
|---|---|---|---|---|---|
| | Toner characteristics | | | Low-temperature | End part |
| | | | tan | fixability | stains of |
| | tan | tan | δ(90)/tan | (minimum fixing | recording |
| | δ(min) | δ(90) | δ(min) | temperature) | medium |
| Example 1 | 0.85 | 1.65 | 1.9 | A | A+ |
| Example 2 | 0.82 | 1.68 | 2.0 | A | A |
| Example 3 | 1.00 | 2.40 | 2.4 | C | C |
| Example 4 | 0.60 | 1.58 | 2.6 | B | C |
| Example 5 | 0.89 | 2.00 | 2.2 | B | A |
| Example 6 | 0.50 | 1.27 | 2.5 | C | C |
| Example 7 | 0.83 | 1.66 | 2.0 | A | C |
| Example 8 | 0.83 | 1.67 | 2.0 | A | C |
| Example 9 | 0.82 | 1.66 | 2.0 | A | C |
| Example 10 | 0.84 | 1.60 | 1.9 | A | B |
| Example 11 | 0.81 | 1.57 | 1.9 | A | A |
| Example 12 | 0.83 | 1.60 | 1.9 | A | A |
| Example 13 | 0.84 | 1.66 | 2.0 | A | B |
| Example 14 | 0.83 | 1.64 | 2.0 | A | C |
| Example 15 | 0.92 | 2.30 | 2.5 | C | B |
| Example 16 | 0.96 | 2.52 | 2.6 | C | C |
| Example 17 | 0.91 | 1.65 | 1.8 | C | B |
| Example 18 | 0.89 | 1.68 | 1.9 | A | A |
| Example 19 | 0.81 | 1.70 | 2.1 | A | A |
| Example 20 | 0.77 | 1.61 | 2.1 | B | B |
| Example 21 | 0.95 | 1.50 | 1.6 | C | B |
| Example 22 | 0.70 | 1.74 | 2.5 | A | B |
| Example 23 | 0.90 | 1.66 | 1.8 | B | A |
| Example 24 | 0.60 | 1.80 | 3.0 | B | C |
| Example 25 | 0.74 | 1.37 | 1.9 | B | C |
| Example 26 | 0.85 | 1.70 | 2.0 | A | B |
| Example 27 | 0.90 | 1.99 | 2.2 | B | A |
| Example 28 | 0.94 | 2.52 | 2.7 | C | C |
| Example 29 | 0.70 | 1.29 | 1.8 | B | C |
| Example 30 | 0.77 | 1.33 | 1.7 | A | B |
| Example 31 | 0.87 | 1.76 | 2.0 | A | A |
| Example 32 | 0.90 | 2.40 | 2.7 | B | C |
| Example 33 | 0.86 | 1.66 | 1.9 | A | A+ |
| Example 34 | 0.86 | 1.69 | 2.0 | A | A |
| Example 35 | 0.85 | 1.65 | 1.9 | A | A |
| Example 36 | 0.85 | 1.65 | 1.9 | A | A |
| Example 37 | 0.90 | 2.25 | 2.5 | B | B |
| Example 38 | 0.87 | 1.74 | 2.0 | A | A |
| Comparative | 0.83 | 1.70 | 2.0 | A | D |
| Example 1 | | | | | |
| Comparative | 0.81 | 1.66 | 2.0 | D | D |
| Example 2 | | | | | |
| Comparative | 1.10 | 2.37 | 2.2 | D | D |
| Example 3 | | | | | |
| Comparative | 0.48 | 1.45 | 3.0 | C | D |
| Example 4 | | | | | |
| Comparative | 0.85 | 1.70 | 2.0 | B | D |
| Example 5 | | | | | |
| Comparative | 0.85 | 1.69 | 2.0 | A | D |
| Example 6 | | | | | |

From the above results, it is found that the toners of the present example can suppress the end part stains of the recording medium while having low-temperature fixability, as compared with the toners of the comparative examples.

The present exemplary embodiments include the following aspects.

(((1)))

An electrostatic charge image developing toner comprising:
toner particles that contain an amorphous polyester resin and a crystalline resin as a binder resin,
wherein the toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B),
a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is 0.5% or more and 10.0% or less in terms of molar ratio, and
in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less,

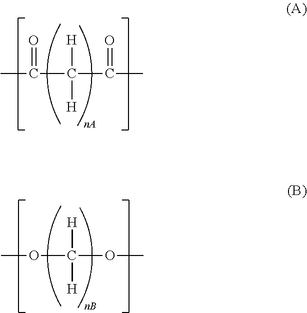

in Structural formulae (A) and (B), nA and nB each independently represent an integer of 2 or more and 12 or less.
   (((2)))

The electrostatic charge image developing toner according to (((1))),
wherein the amorphous polyester resin (S) has only the constitutional unit derived from the aliphatic dicarboxylic acid represented by Structural formula (A) among the constitutional unit derived from the aliphatic dicarboxylic acid represented by Structural formula (A) and the constitutional unit derived from the aliphatic diol represented by Structural formula (B), and
a proportion of the constitutional unit derived from the aliphatic dicarboxylic acid represented by Structural formula (A) with respect to all constitutional units derived from dicarboxylic acid constituting the amorphous polyester resin is 2.0 or more and 15.0% or less in terms of molar ratio.
   (((3)))

The electrostatic charge image developing toner according to (((2))), wherein the proportion of the constitutional unit derived from the aliphatic dicarboxylic acid represented by Structural formula (A) with respect to all constitutional units derived from dicarboxylic acid constituting the amorphous polyester resin is 3.0 or more and 10.0% or less in terms of molar ratio.

(((4)))

The electrostatic charge image developing toner according to any one of (((1))) to (((3))),
wherein the minimal value tan δ(min) of the loss tangent is 0.60 or more and 0.90 or less.
   (((5)))

The electrostatic charge image developing toner according to any one of (((1) to (((4))),
wherein a ratio tan δ(90)/tan δ(min) of a loss tangent tan δ(90) at a temperature of 90° C. to the minimal value tan δ(min) of the loss tangent is 2.5 or less.
   (((6)))

The electrostatic charge image developing toner according to any one of (((1))) to (((5))),
wherein the toner particles include internally-added crosslinked resin particles.
   (((7)))

The electrostatic charge image developing toner according to (((6))), wherein a glass transition temperature Tg of the internally-added crosslinked resin particles is 0° C. or higher and 40° C. or lower.

(((8)))

The electrostatic charge image developing toner according to any one of (((1))) to (((7))),
wherein the crystalline resin is a crystalline polyester resin, and
a content of the crystalline polyester resin with respect to the binder resin is 10% by mass or more and 30% by mass or less.
   (((9)))

The electrostatic charge image developing toner according to any one of (((1))) to (((8))),
wherein the toner particles contain one or more metal ions selected from the group consisting of Al, Mg, and Ca, and
a ratio AV1/M1 of an acid value AV1 of the binder resin to an amount M1 of the metal ions is 1.0×10³ or more and 4.0×10³ or less.
   (((10)))

The electrostatic charge image developing toner according to (((9))),
wherein the ratio AV1/M1 of the acid value AV1 of the binder resin to the amount M1 of the metal ions is 2.0×10³ or more and 3.5×10³ or less.
   (((11)))

An electrostatic charge image developer comprising:
the electrostatic charge image developing toner according to any one of (((1))) to (((10))).
   (((12)))

A toner cartridge comprising:
a container that contains the electrostatic charge image developing toner according to any one of (((1))) to (((10))),
wherein the toner cartridge is detachable from an image forming apparatus.
   (((13)))

A process cartridge comprising:
a developing device that contains the electrostatic charge image developer according to (((11))) and develops an electrostatic charge image formed on a surface of an image holder as a toner image using the electrostatic charge image developer,
wherein the process cartridge is detachable from an image forming apparatus.
   (((14)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((11))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.
   (((15)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to (((11)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that contain an amorphous polyester resin and a crystalline resin as a binder resin,
wherein the toner particles contain, as the amorphous polyester resin, an amorphous polyester resin (S) that has at least one of a constitutional unit derived from an aliphatic dicarboxylic acid represented by Structural formula (A) or a constitutional unit derived from an aliphatic diol represented by Structural formula (B),
a proportion of a total of the constitutional unit derived from the aliphatic dicarboxylic acid represented by Structural formula (A) and the constitutional unit derived from the aliphatic diol represented by Structural formula (B) with respect to all constitutional units constituting the amorphous polyester resin is 0.5% or more and 10.0% or less in terms of molar ratio, and
in a dynamic viscoelasticity measurement of the toner particles in a case where a temperature is raised from 30° C. to 120° C., a minimal value tan δ(min) of a loss tangent is present at 50° C. or higher and 80° C. or lower and is 0.50 or more and 1.00 or less, 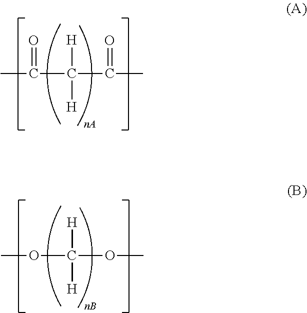
in Structural formulae (A) and (B), nA and nB each independently represent an integer of 2 or more and 12 or less.

2. The electrostatic charge image developing toner according to claim 1,
wherein the amorphous polyester resin (S) has only the constitutional unit derived from the aliphatic dicarboxylic acid represented by Structural formula (A) among the constitutional unit derived from the aliphatic dicarboxylic acid represented by Structural formula (A) and the constitutional unit derived from the aliphatic diol represented by Structural formula (B), and
a proportion of the constitutional unit derived from the aliphatic dicarboxylic acid represented by Structural formula (A) with respect to all constitutional units derived from dicarboxylic acid constituting the amorphous polyester resin is 2.0 or more and 15.0% or less in terms of molar ratio.

3. The electrostatic charge image developing toner according to claim 2,
wherein the proportion of the constitutional unit derived from the aliphatic dicarboxylic acid represented by Structural formula (A) with respect to all constitutional units derived from dicarboxylic acid constituting the amorphous polyester resin is 3.0 or more and 10.0% or less in terms of molar ratio.

4. The electrostatic charge image developing toner according to claim 1,
wherein the minimal value tan δ(min) of the loss tangent is 0.60 or more and 0.90 or less.

5. The electrostatic charge image developing toner according to claim 1,
wherein a ratio tan δ(90)/tan δ(min) of a loss tangent tan δ(90) at a temperature of 90° C. to the minimal value tan δ(min) of the loss tangent is 2.5 or less.

6. The electrostatic charge image developing toner according to claim 1,
wherein the toner particles include internally-added crosslinked resin particles.

7. The electrostatic charge image developing toner according to claim 6,
wherein a glass transition temperature Tg of the internally-added crosslinked resin particles is 0° C. or higher and 40° C. or lower.

8. The electrostatic charge image developing toner according to claim 1,
wherein the crystalline resin is a crystalline polyester resin, and
a content of the crystalline polyester resin with respect to the binder resin is 10% by mass or more and 30% by mass or less.

9. The electrostatic charge image developing toner according to claim 1,
wherein the toner particles contain one or more metal ions selected from the group consisting of Al, Mg, and Ca, and
a ratio AV1/M1 of an acid value AV1 of the binder resin to an amount M1 of the metal ions is 1.0×10³ or more and 4.0×10³ or less.

10. The electrostatic charge image developing toner according to claim 9,
wherein the ratio AV1/M1 of the acid value AV1 of the binder resin to the amount M1 of the metal ions is 2.0×10³ or more and 3.5×10³ or less.

11. An electrostatic charge image developer comprising:
the electrostatic charge image developing toner according to claim 1.

12. An electrostatic charge image developer comprising:
the electrostatic charge image developing toner according to claim 2.

13. An electrostatic charge image developer comprising:
the electrostatic charge image developing toner according to claim 3.

14. An electrostatic charge image developer comprising:
the electrostatic charge image developing toner according to claim 4.

15. An electrostatic charge image developer comprising:
the electrostatic charge image developing toner according to claim 5.

16. An electrostatic charge image developer comprising:
the electrostatic charge image developing toner according to claim 6.

17. A toner cartridge comprising:
a container that contains the electrostatic charge image developing toner according to claim 1,
wherein the toner cartridge is detachable from an image forming apparatus.

18. A process cartridge comprising:
a developing device that contains the electrostatic charge image developer according to claim 11 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 11 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 11;
transferring the toner image formed on the surface of the image holder to a surface of a recording medium; and
fixing the toner image transferred to the surface of the recording medium.
